(19) United States
(12) Patent Application Publication
(10) Pub. No.: US 2010/0172039 A1
(43) Pub. Date: Jul. 8, 2010

(54) DETECTION DEVICE AND METHOD FOR DETECTING AUTO-FOCUS LENS

(75) Inventors: KUAN-TENG TSAI, Tu-Cheng (TW); CHUN-HSIEN YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/475,502

(22) Filed: May 30, 2009

(30) Foreign Application Priority Data
Jan. 5, 2009 (CN) 200910300048.3

(51) Int. Cl. G02B 7/02

(52) U.S. Cl. 359/823

(57) ABSTRACT

A detection device for detecting a displacement of a lens unit of an auto-focus lens during focusing includes a bracket having a rotary plate, a seat fixed on an end of the rotary plate, a sensor mounted on an opposite end of the rotary plate, and a driver. During detection, the driver drives the rotary plate into rotation to position the lens unit at a required state and drives the lens unit of the auto-focus lens to focus. The sensor detects the displacement of the lens unit during focusing in the required state. If the detected displacements of the lens unit conform to the standard in all of the required states, the auto-focus lens is deemed acceptable for a further use; otherwise, the auto-focus lens is deemed as being unacceptable.

### BACKGROUND

1. Technical Field

The disclosure generally relates to detection devices, and particularly to a detection device for detecting an auto-focus lens and a method detecting the auto-focus lens using the detecting device.

2. Description of Related Art

Usually we need a camera to record memorable moments. The camera includes a lens unit and a motor to drive the lens unit into telescopically movement to focus. During focusing, the lens moves back and forth between focus points thereof to capture the clearest image. However, the designs of cameras have evolved toward lightweight and compactness, a displacement of the lens unit during focusing usually just 200˜300 micrometer, and thus should be precision. In addition, the camera usually has different using states, and in each state the movement of the lens should be kept in precision. Thus a detection of the movement of the lens unit of the camera in different states is important to the camera.

For the foregoing reasons, therefore, there is a need in the art for a detection device and a detection method for detecting a movement of an auto-focus lens during focusing which overcomes the limitations described.

### BRIEF DESCRIPTION OF THE DRAWINGS

FIG. 1 is a schematic view of a detecting device for detecting an auto-focus lens according to an exemplary embodiment.

FIG. 2 is an isometric view of a seat of the detecting device of FIG. 1 in an open state.

FIG. 3 is similar to FIG. 2, but shows the auto-focus lens being mounted into the seat.

FIG. 4 shows the seat being closed after the lens is assembled.

FIG. 5 shows the auto-focus lens detected at a normal state.

FIG. 6 shows the auto-focus lens detected at a transverse state.

FIG. 7 shows the auto-focus lens detected at an inverted state.

FIG. 8 is a flow chart of a detection method for detecting the auto-focus lens using the detection device of FIG. 1.

FIG. 9 is a flow chart showing how to detect a displacement of the auto-focus lens in each state.

### DETAILED DESCRIPTION

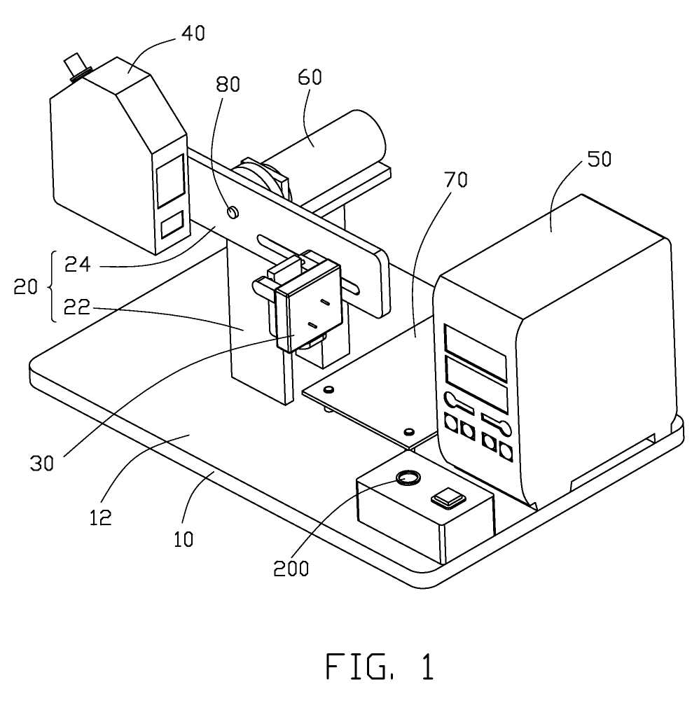

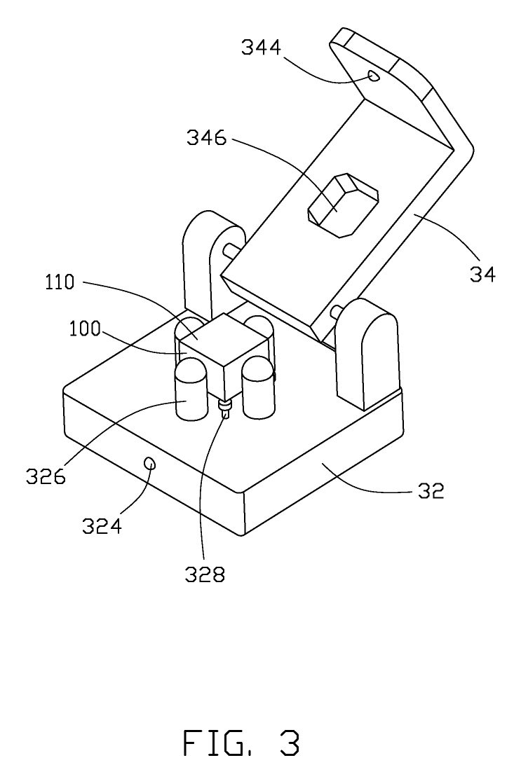

Referring to FIG. 1, a detection device for detecting an auto-focus lens 100 (FIG. 3) according to an exemplary embodiment is shown. The auto-focus lens 100 includes a lens unit and an actuator for driving the lens unit into telescopic movement for focusing. The detection device is used to detect a displacement of the lens unit in different states, and includes a base 10, a bracket 20, a seat 30, a sensor 40, a comparator 50, a motor 60 and a driver 70.

The base 10 is flat, and has a planar-shaped mounting surface 12 formed at a top side thereof. The bracket 20 is arranged on the mounting surface 12 of the base 10. The bracket 20 includes an elongated, fixed plate 22 with a bottom end thereof fixed onto the base 10, and an elongated rotary plate 24 rotatably connected to a top end of the fixed plate 22. The motor 60 is arranged at a rear side of the bracket 20. Preferably, the motor 60 is a servo motor, and has a shaft 80 extending through a top end of the fixed plate 22 into a middle of the rotary plate 24 to connect the fixed plate 22 and the rotary plate 24 together. The shaft 80 is rotatable with aspect to the fixed plate 22, whilst is fixed to the rotary plate 24 through interference fitting. During operation of the motor 60, a rotation of the shaft 80 causes the rotary plate 24 to rotate synchronously.

The seat 30 and the sensor 40 are respectively arranged near two ends of the rotary plate 24 of the bracket 20. The seat 30 is used to accommodate the auto-focus lens 100 which needs to be detected. The sensor 40 faces the seat 30 for detecting the displacement of the lens unit of the auto-focus lens 100. The sensor 40 can be a radium displacement sensor or a capacitive displacement sensor. The comparator 50 is electronically connected to the sensor 40 to receive a signal of the sensor 40. The driver 70 is arranged on the base 10 and electronically connected to the motor 60 and the actuator of the auto-focus lens 100. The connection between the elements of the detection device, such as the comparator 50, the sensor 40, the auto-focus lens 100, the motor 60, the driver 70, can be conventional means, such as wires, and is not shown for simplifying the drawings.

During detection, the detection device detects displacements of the lens unit in different states, i.e., normal state, transverse state and inverted state. In the detection of each state, the driver 70 causes the rotary plate 24 of the bracket 20 to rotate to change a state of the auto-focus lens 100, and then causes the actuator of the auto-focus lens 100 into operation to drive the lens unit into movement to focus. The sensor 40 senses the displacement of the lens unit of auto-focus lens 100 during focusing and outputs a corresponding signal to the comparator 50. Finally the comparator 50 compares the signal of the sensor 40 with the standard value which is stored in the comparator 50 in advance, and outputs a single indicating if the auto-focus lens 100 is up to the standard, according to the compared result.

For facilitating the indication weather the displacement of the lens unit conforms to the standard value, an indicator lamp 200 is connected to the comparator 50. If the compared result is outside the predetermined value, which means that the displacement of the lens unit does not conform to the standard value, the indicator lamp 200 is lighted to tell the inspector that the auto-focus lens 100 does not pass the test and should be rejected for a further disposal. Thus the detection is ended. On the other hand, if the compared result falls within the predetermined value, which means that the displacement of the lens unit in this state conforms to the standard value, the indicator lamp 200 is unlighted to tell the inspector that the detection of the auto-focus lens 100 in this state passes the requirement, and the detection in other states can be continued. Until all of the three states are detected and the displacements of the auto-focus lens 100 in the three states are all within the predetermined values, the auto-focus lens 100 can be deemed as passing the test and can be delivered for a further use.

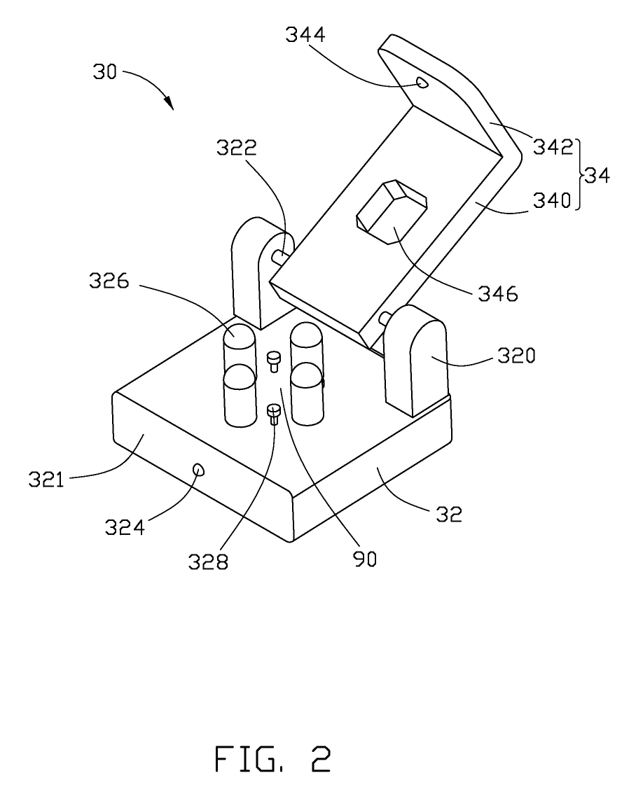

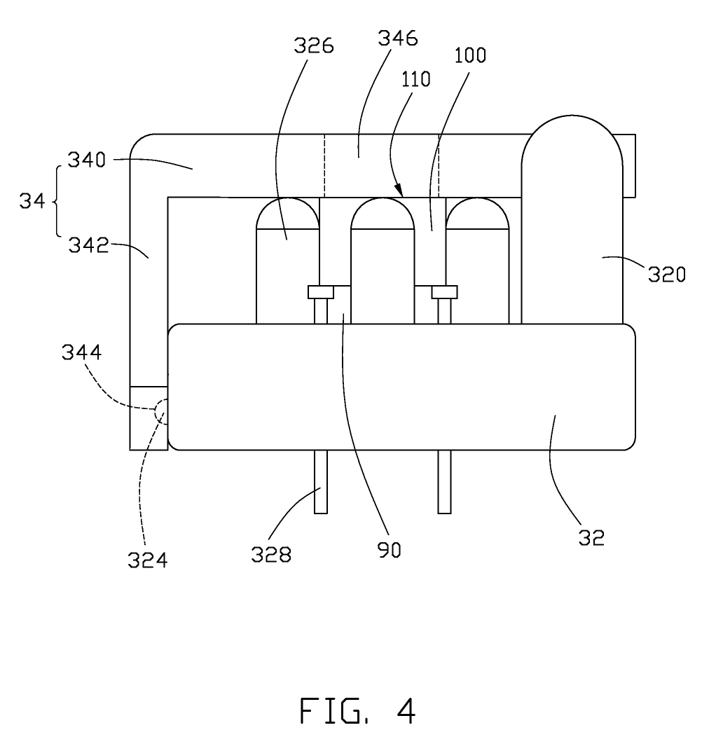

Referring to FIG. 2-4, the seat 30 includes a mounting plate 32 and a cover 34. The mounting plate 32 is substantially square. A pair of blocks 320 extend respectively upwardly from two neighboring corners of the mounting plate 32 at a rear side of the mounting plate 32. The blocks 320 are spaced from each other. A protrusion 324 is formed at a middle of a front side surface 321 of the mounting plate 32. Four posts 326 extend upwardly from a top surface of the mounting plate 32, and are respectively positioned at four corners of an imaginary square. A space 90 is thus defined among the four posts 326 for accommodating the auto-focus lens 100 therein. A pair of pins 328 are formed in the space 90, and extend downwardly through the mounting plate 32 with bottom ends thereof below the mounting plate 32.

The cover 34 includes a main body 340 and an engaging portion 342. When the main body 340 is oriented over and parallel to the top surface of the mounting plate 32, the engaging portion 342 extends perpendicularly and downwardly from a front edge of the main body 340. A pole 322 extends through a rear edge of the main body 340 of the cover 34 with two ends thereof respectively and pivotally engaging into the blocks 320 of the mounting plate 32. Thus the cover 34 is pivotally connected to the mounting plate 32 to form the seat 30. An aperture 346 is defined in a central portion of the main body 340 of the cover 34, communicating with the space 90 of the mounting plate 32. The aperture 346 is slightly smaller than the auto-focus lens 100. A concave 344 is defined in an inner side of the engaging portion 342, located corresponding to the protrusion 324 of the mounting plate 32.

When assembly, the auto-focus lens 100 is mounted into the space 90 and set on the pins 328, and the actuator of the auto-focus lens 100 is electronically connected to the pins 328. Then the cover 34 is rotated to secure the auto-focus lens 100 on the seat 30. The protrusion 324 of the mounting plate 32 extends into the concave 344 of the cover 34 to lock the seat 30 at the closed position. Thus the auto-focus lens 100 is fixed on the seat 30 with a top side thereof abutting the cover 34 at a position around the aperture 346. The bottom ends of the pins 328 below the seat 30 are respectively connected to the driver 70. Thus the driver 70 can supply currents to the actuator of the auto-focus lens 100 to drive the lens unit into a telescopic movement.

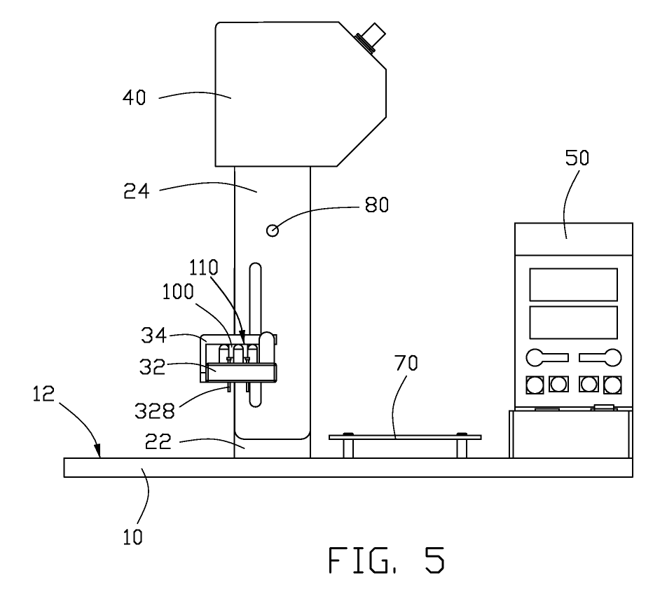

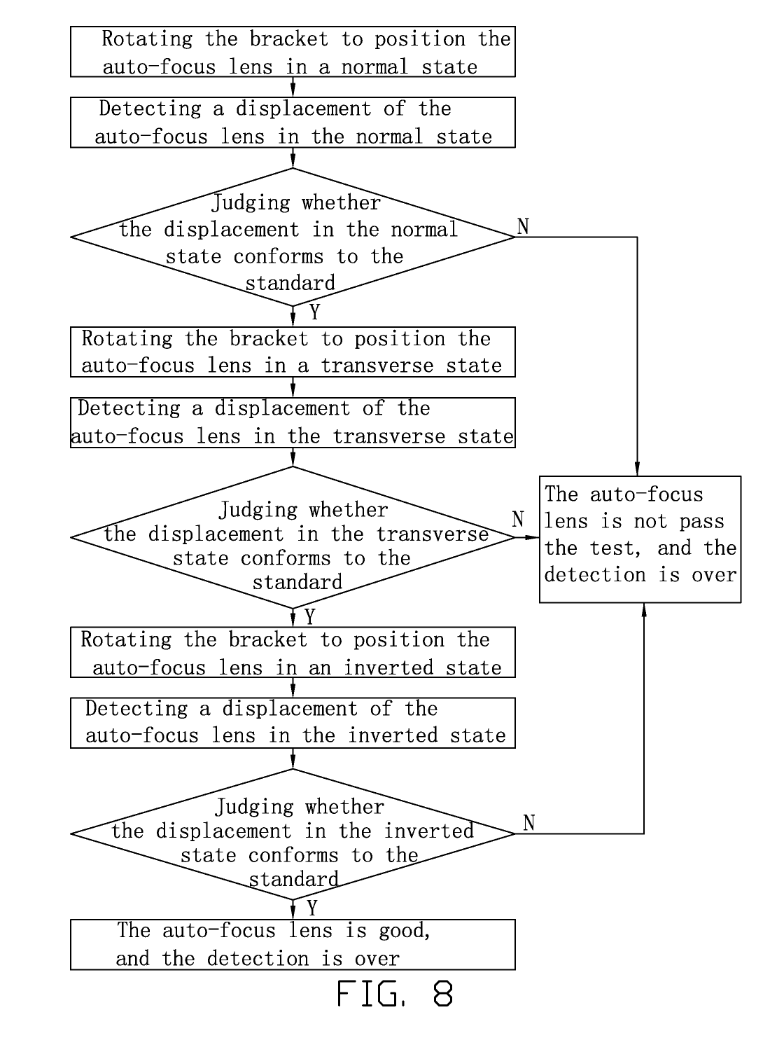

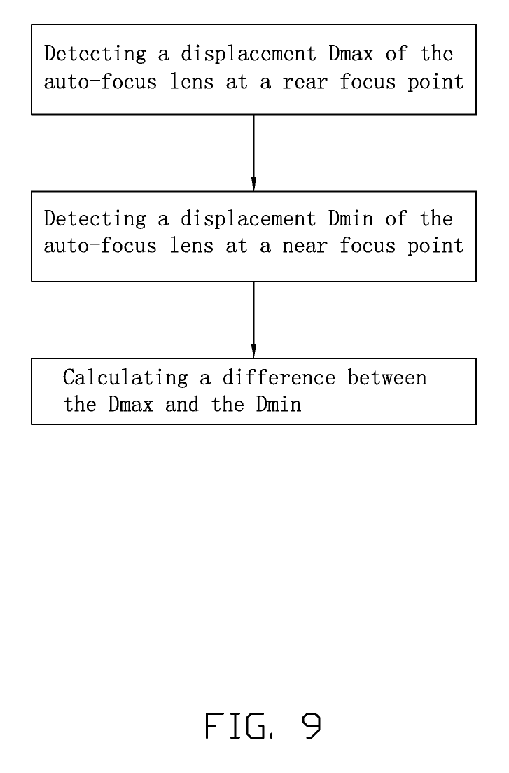

Referring to FIG. 8, after the auto-focus lens 100 is fixed onto the seat 30, the detection can be started. Referring to FIG. 5 also, firstly, the driver 70 drives the motor 60 into rotation. The rotary plate 24 rotates with the shaft 80 of the motor 60 to cause the auto-focus lens 100 reach a normal state, i.e., the top surface 110 of the auto-focus lens 100 being horizontal, and the sensor 40 being located over the auto-focus lens 100. Then the driver 70 drives the actuator of the auto-focus lens 100 into operation. The lens unit thus moves telescopically to focus. Referring to FIG. 9, firstly the lens unit moves to a rear focus point thereof, and during this movement, the sensor 40 detect a displacement Dmax of the lens unit. Then the lens unit moves to a near focus point thereof, and the sensor 40 detect a displacement Dmin of the lens unit. Finally the sensor 40 calculates a difference by subtracting Dmin from Dmax and generates a signal corresponding to the difference to the comparator 50. Thus the comparator 50 compares the output signal of the sensor 40 with the standard value and outputs a signal indicating if the displacement of the auto-focus lens 100 at the normal state conforms to the standard value. If the answer is negative, the auto-focus lens 100 does not pass the test, and the detection for this auto-focus lens 100 should be over. On the other hand, if the displacement of the auto-focus lens 100 in the normal state conforms to the standard value, the detection of the auto-focus lens 100 in other states should be continued.

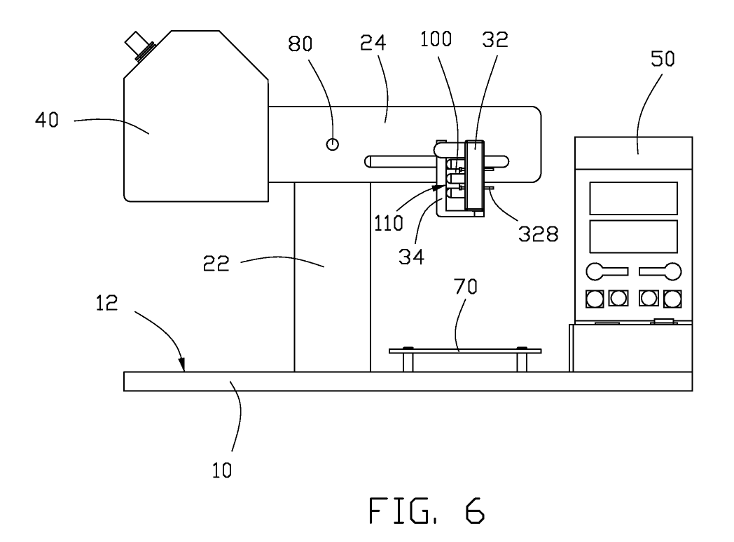

Referring to FIG. 6, the auto-focus lens 100 is detected in the transverse state after the auto-focus lens 100 passes the normal state detection. In such a situation, the driver 70 drives the rotary plate 24 of the bracket 20 to be horizontal. The sensor 40 and the seat 30 are at the same level, and the sensor 40 is located at a left side of the seat 30. The top surface 110 of the auto-focus lens 100 is vertical. Then the driver 70 drives the lens unit to move. Similar to the detection in the normal state, the lens unit moves to the rear focus point and the near focus point respectively, and the sensor 40 detect the displacement Dmax at the rear focus point and the displacement Dmin at the near focus point. Finally the sensor 40 calculates the difference between the displacements of Dmax and Dmin, and generates a signal corresponding to the difference to the comparator 50. Thus the comparator 50 outputs a signal indicating if the auto-focus lens 100 at the transverse state conforms to the standard value. If the answer is negative, the auto-focus lens 100 does not pass the test and the detection is ended. On the other hand, if the auto-focus lens 100 in the transverse state passes the test, the detection of the auto-focus lens 100 in the inverted state should be continued.

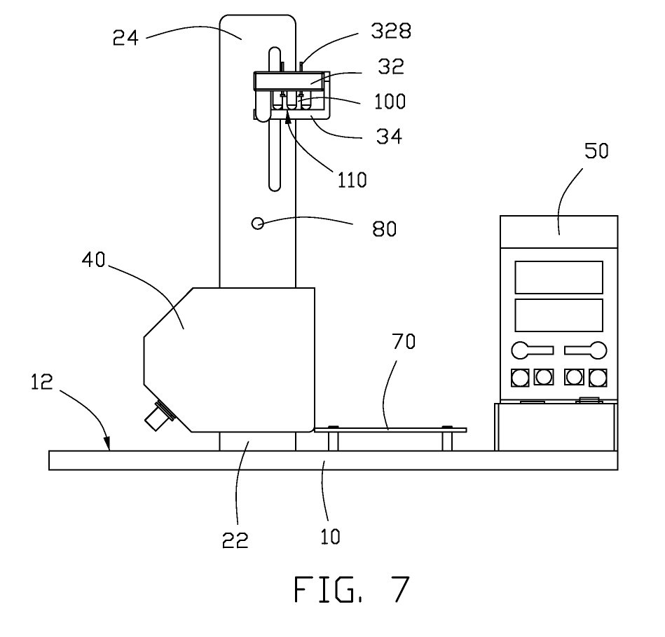

FIG. 7 shows the auto-focus lens 100 is detected in the inverted state. In such a situation, the driver 70 drives the rotary plate 24 of the bracket 20 to be vertically again and the top surface 110 of the auto-focus lens 100 is kept horizontal. Different to the normal state, the seat 30 is over the sensor 40. The driver 70 drives the lens unit to move to the rear focus point and the near focus point respectively. The sensor 40 senses the displacement Dmin at the rear focus point and the displacement Dmax at the near focus point, and calculates a difference between the displacements of Dmin and Dmax. The comparator 50 outputs a signal indicating if the auto-focus lens 100 at the inverted state conforms to the standard value, according to the difference. If the answer is negative, the auto-focus lens 100 does not pass the test. On the other hand, if the auto-focus lens 100 in the inverted state conforms to the standard value, the auto-focus lens 100 passes the detection in all of the three states and can be delivered to a next use, for example, selling to a customer or assembly to other parts of a device such as a digital camera or a mobile phone. The detection process for the auto-focus lens 100 is over.

The present detection device and method are used to detect the auto-focus lens 100 in different states, i.e., normal state, transverse state and inverted state; it is to be understood that the order of the three states can be exchanged, such as the auto-focus lens 100 is first detected in the inverted state, and then in the transverse state and finally in the normal state. As described above, the present detection device has a rotary plate 24 on which the auto-focus lens 100 is fixed. Thus the auto-focus lens 100 can have different detection states by rotating the rotary plate 24, which is simple and easy.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A detection device for detecting a displacement of a lens unit of an auto-focus lens during focusing to judge whether the lens unit is up to a standard, comprising:
a bracket having a rotary plate;
a seat fixed on an end of the rotary plate for receiving the auto-focus lens therein;
a driver for driving the rotary plate into rotation to change a state of the auto-focus lens and for driving the lens unit of the auto-focus lens to focus; and
a sensor mounted on an opposite end of the rotary plate for detecting the displacement of the lens unit during focusing.

2. The detection device of claim 1, further comprising a comparator connected to the sensor electronically, the comparator comparing a signal output from the sensor and a standard value stored in the comparator, and outputting a signal according to a compared result indicating whether the auto-focus lens conforms to the standard value.

3. The detection device of claim 1, wherein the bracket further comprises a fixed plate, the rotary plate being rotatably connected to the fixed plate through a shaft, and rotates with the shaft.

4. The detection device of claim 3, further comprising a motor connected to the driver electronically, the shaft being an output shaft of the motor.

5. The detection device of claim 1, wherein the seat comprises a mounting plate and a cover, a pair of pins extending through the mounting plate for connecting the auto-focus lens to the driver electronically.

6. The detection device of claim 5, wherein a plurality of posts are formed between the mounting plate and the cover, a space being defined among the posts for accommodating the auto-focus lens therein, the pins being located in the space.

7. The detection device of claim 6, wherein an aperture is defined in the cover communicating with the space.

8. The detection device of claim 7, wherein the aperture has a size not larger than that of the auto-focus lens, and the auto-focus lens abuts the cover around the aperture when the auto-focus lens is assembled into the seat and the cover is locked to the mounting plate.

9. The detection device of claim 5, wherein one side of the cover is rotatably connected to the mounting plate, and an opposite side of the cover forms a concave, the mounting plate forming a protrusion engaging into the concave to lock the cover onto the mounting plate.

10. A method for detecting a displacement of a lens unit of an auto-focus lens during focusing to judge whether the auto-focus lens is up to a standard, comprising steps of:
a) providing a bracket having a rotary plate;
b) providing and fixing an auto-focus lens onto an end of the rotary plate;
c) providing a sensor and fixing the sensor onto an opposite end of the rotary plate;
d) rotary the rotary plate of the bracket to cause the auto-focus lens into one of a normal state, an inverted state and a transverse state;
e) driving the lens unit of the auto-focus lens to focus and detecting a displacement of the lens unit by the sensor; and
f) judging whether the auto-focus lens in this state conforms to the standard according to the detected displacement;
wherein if the detected displacement in step f) does not conform to the standard, the detection is over, and if the detected displacement in step f) conforms to the standard, the rotary plate of the bracket is rotated to change the state of the auto-focus lens to another one of the normal state, the inverted state and the transverse state and steps of e) and f) are repeated.

11. The method of claim 10, wherein firstly the auto-focus lens is detected in the normal state, and then is detected in the transverse state, and finally is detected in the inverted state.

12. The method of claim 10, wherein detecting a displacement of the lens unit in step e) comprising: detecting the displacement of the lens unit at a rear focus point; detecting the displacement of the lens unit at a near focus point, and calculating a difference between the displacements at the rear focus point and at the near focus point.

13. The method of claim 10, wherein the rotary plate is connected to a shaft of a motor, and rotates with the shaft of the motor.

14. The method of claim 10, wherein a seat is fixed on the rotary plate receiving the auto-focus lens therein, a pair of pins extending through the seat to electronically connect the auto-focus lens to a driver which drives the rotary plate and the auto-focus lens into operation.
